(19) United States
(12) Patent Application Publication
(10) Pub. No.: US 2021/0078152 A1
(43) Pub. Date: Mar. 18, 2021

(54) HANDHELD TOOL

(71) Applicant: ERGOBIONIK GmbH, Iserlohn (DE)

(72) Inventor: Thomas KLINGBEIL, Iserlohn (DE)

(21) Appl. No.: 17/025,177

(22) Filed: Sep. 18, 2020

(30) Foreign Application Priority Data
Sep. 18, 2019 (DE) 102019125171.0

(51) Int. Cl. B25F 1/04; B25F 3/00; B25F 5/00; B25F 5/02

(52) U.S. Cl. CPC B25F 1/04; B25F 5/02; B25F 5/001; B25F 3/00

(57) ABSTRACT

The invention relates to a motor-driven handheld tool for drilling and/or screwdriving, having a housing in which a motor drive system having a rotatably mounted drive shaft connected thereto is provided, and on which a turret head, which is equipped at least with a drivable first coupling head having a receptacle for a screwdriving tool and with a second coupling head having a receptacle for a drilling tool, is arranged by means of a rotary bearing; the coupling heads being capable of being pivoted alternatively both into a driven working position and into a non-driven parked position; a shiftable gearbox having at least a first gear ratio having a lower rotation speed and higher torque, and a second gear ratio having a higher rotation speed and lower torque, being provided.

### CROSS-REFERENCE TO RELATED APPLICATIONS AND CLAIM TO PRIORITY

This application is related to Patent Application No. 10 2019 125 171.0 filed Sep. 18, 2019 in Germany, the disclosure of which is incorporated herein by reference and to which priority is claimed.

### FIELD OF THE INVENTION

The invention relates to a motor-driven handheld tool for drilling and/or screwdriving, having a housing in which on the one hand a motor drive system having a rotatably mounted drive shaft connected thereto is provided, and on which on the other hand a turret head, which is equipped at least with a drivable first coupling head having a receptacle for a screwdriving tool and with a second coupling head having a receptacle for a drilling tool, is arranged by means of a rotary bearing; the coupling heads being capable of being pivoted alternatively both into a driven active position and into a non-driven parked position; the handheld tool encompassing a shiftable gearbox having at least a first gear ratio having a lower rotation speed and higher torque, and a second gear ratio having a higher rotation speed and lower torque.

### BACKGROUND OF THE INVENTION

Handheld tools of this kind are known from practical use in a variety of manifestations, for example from WO 2006/108220 A. The motor drive system as a rule is connected via a conversion gearbox to the turret head, and the first coupling head that serves for screwdriving is preceded by a stepdown gearbox, since usually the rotation speed is intended to be lower, and the torque higher, in the context of screwdriving.

It is often the case in practice that a number of screws need to be driven in, firstly pilot holes being drilled and then the screw being driven in. Depending on the drill being used and the material to be drilled, it can be the case that either a higher or a lower drilling speed is required, whereas screwdriving is always effected using a low speed. Handheld tools known from the existing art are disadvantageous in that the rotation speed of the coupling head provided for drilling is not modifiable.

### SUMMARY OF THE INVENTION

The object of the invention is to eliminate the aforesaid disadvantages and to describe a handheld tool of the species with which corresponding utilization of a handheld tool of the species as described above is possible.

This object is achieved by the fact that a control system of the gearbox is provided in such a way that the first gear ratio is activated when the first coupling head is active, and the first or second gear ratio is usable when the second coupling head is active. As a result, drilling can also be effected using the first gear ratio, if that is necessary and/or desired based on the circumstances.

Advantageously, the control system can be embodied in such a way that upon the change from the second coupling head to the first coupling head, a switchover into the first gear ratio is automatically effected. Thus, upon the change from the active second coupling head used for drilling to the first coupling head to be used for screwdriving, a manual shift into the first gear ratio is not necessary so long as the second gear ratio was used (as it usually is) for drilling. Because a manual shift to the lower gear ratio does not need to occur, such shifting also cannot be forgotten, and incorrect operation of the handheld tool involving screwdriving using the second gear ratio can reliably be avoided.

According to the present invention the control system can be embodied in such a way that upon the change from the first coupling head to the second coupling head, a switchover into the gear ratio that was set before utilization of the first gear ratio is automatically effected. For application instances in which a number of screws must be driven in, and in that regard firstly a respective pilot hole is drilled and then the screw is driven in, It is thus not necessary to effect, after each change of the active coupling head back to the second coupling head used for drilling, a respective manual switchover to the previously used drilling speed.

The handheld tool can preferably have a pistol-like shape with an elongated body and a handle provided at an angle thereto, the rotation axis of the rotary bearing of the turret head being oriented at an angle of approximately 30 to 60 degrees with respect to the longitudinal extent of the elongated body.

According to the present invention, the coupling heads can be provided on the turret head in such a way that the active coupling head aligns with the elongated body, and the non-active coupling head is located below, facing to the rear at an obtuse angle with respect to the active coupling head.

In a preferred exemplifying embodiment of the invention, when the second coupling head is active, the active gear ratio can be selectable manually by means of an actuation element, preferably in the form of a sliding element, or a control system can be provided which switches over the gear ratio on the basis of the load.

Advantageously, the control system of the gearbox can be embodied entirely mechanically, and the gearbox can comprise for that purpose a lever displaceable between positions corresponding to the first gear ratio or to the second gear ratio. Electronic components for the gearbox control system are thus omitted, so that malfunctions caused by them cannot occur.

The displacement direction of the lever can be oriented in alignment with the longitudinal extent of the elongated body of the handheld tool, which makes possible simplified handling.

In addition, when the first gear ratio is set, the lever can be in a setting that faces away from the turret head, and when the second gear ratio is set, the lever can be in a setting that faces toward the turret head, thereby making possible more-intuitive operation even without detailed inspection and consideration of a label on the lever.

The turret head can preferably be equipped with an eccentric by way of which the lever is actuatable, directly or via at least one connecting element, for shifting into the first gear ratio against the return force of a spring element. The eccentric can be mounted on the turret head or can form part of the turret head; the eccentric is at least nonrotatable with respect to the turret head, and co-rotates with the turret head upon rotation of the turret head when the active coupling head is changed.

A connecting element can be embodied as a slider that comprises an opening having a surrounding edge, the lever being surrounded by the opening and being actuatable by a sub-region of the edge, directly or by way of an interposed spring, upon displacement of the slider.

A connecting element can preferably be embodied as a pushbutton attached to the slider, thus producing a contact surface which is oriented orthogonally to the surface of the slider and on which an actuation force can effectively engage. Alternatively, the contact surface can also be constituted by a bent region of the slider.

A connecting element can furthermore be embodied as a linkage piece which is provided between the pushbutton and eccentric and which on the one hand is displaceable by the eccentric along a guide oriented orthogonally to the rotation axis of the rotary bearing and facing toward the gearbox, and on the other hand has at its one end a contact surface impinged upon by the eccentric and is equipped at its other end with a planar contact region for impingement of the pushbutton. A continuously load-carrying connection from the turret head to the slider, for displacement of the slider upon rotation of the turret head, is thereby effected in technically simple fashion.

According to the present invention, the sliding element can be connected to the slider, directly or via at least one intermediate element, in such a way that shifting into the first gear ratio is effected by sliding of the sliding element when the second coupling head is active. An intermediate element can be embodied as a ring that is arranged translationally displaceably around a sub-region of the gearbox and is displaceable by displacement of the sliding element. The translational displacement can thereby be transferred in simple fashion to the opposite side of the gearbox, since the ring is slidingly translationally displaceable on an appropriately embodied sub-region of the gearbox and, because of the width of the ring, does not tilt.

The ring can also comprise a cam, and the slider can be equipped with an elongated hole, the cam engaging into the elongated hole in such a way that shifting into the first gear ratio is effected by sliding of the sliding element when the second coupling head is active.

Advantageously, the elongated hole can be embodied and arranged in such a way that even when the slider has been displaced by the eccentric, the cam is located unrestrictedly within the elongated hole, so that shifting into the first gear ratio by way of the eccentric has no effect on the sliding element.

In a preferred exemplifying embodiment of the invention, shifting into the first gear ratio can be effected by way of a spring, the spring having a lower spring force than the spring element. Shifting into the first gear ratio can thus be effected even if the gearbox is in a rotational position in which the gear pairing cannot snap in, since engagement is then brought about by the spring upon subsequent rotation of the gearbox.

### BRIEF DESCRIPTION OF THE DRAWINGS

An exemplifying embodiment of the invention is depicted in the drawings and will be explained below. In the drawings:

FIG. 1 is a side view of a handheld tool according to the present invention;

FIG. 2 is an X-ray view of the subject matter of FIG. 1;

FIG. 3 is an enlarged partial view of detail A of FIG. 2;

FIG. 4 is a plan view of the slider;

FIGS. 5 to 8 are partial views of the mechanism present in the interior of what is shown in FIG. 2, in various operating states; and

FIG. 9 is an enlarged partial view of detail B of FIG. 8.

In all the Figures, matching reference characters are used for identical or similar components.

### DETAILED DESCRIPTION OF THE PREFERRED EMBODIMENT(S)

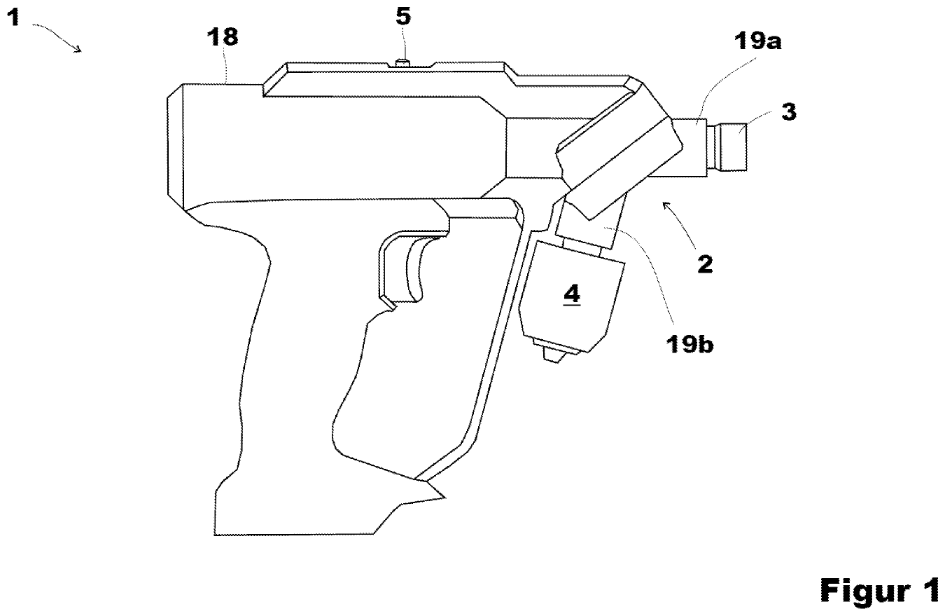

FIG. 1 shows a motor-driven handheld tool 1 for drilling and/or screwdriving. Handheld tool 1 encompasses a housing 18 in which on the one hand a motor drive system (not depicted in the drawings) having a rotatably mounted attached thereto is provided, and on which on the other hand a turret head 2 is arranged by means of a rotary bearing 20. Turret head 2 is equipped at least with a drivable first coupling head 19a having a receptacle for a screwdriving tool 3, and a second coupling head 19b having a receptacle for a drilling tool 4, such that coupling heads 19a, 19b can be alternatively pivoted both into a driven active position and into a non-driven parked position. The handheld tool furthermore encompasses a shiftable gearbox 6 having at least a first gear ratio having a lower rotation speed and higher torque, and a second gear ratio having a higher rotation speed and lower torque.

Provided on the top of housing 18 of handheld tool 1 is a sliding element 5 with which shifting can occur between the first gear ratio and the second gear ratio. The first gear ratio is selected in the setting in which sliding element 5 is in its position facing away from turret head 2, and the second gear ratio is selected in the setting in which sliding element 5 is in its position facing toward turret head 2.

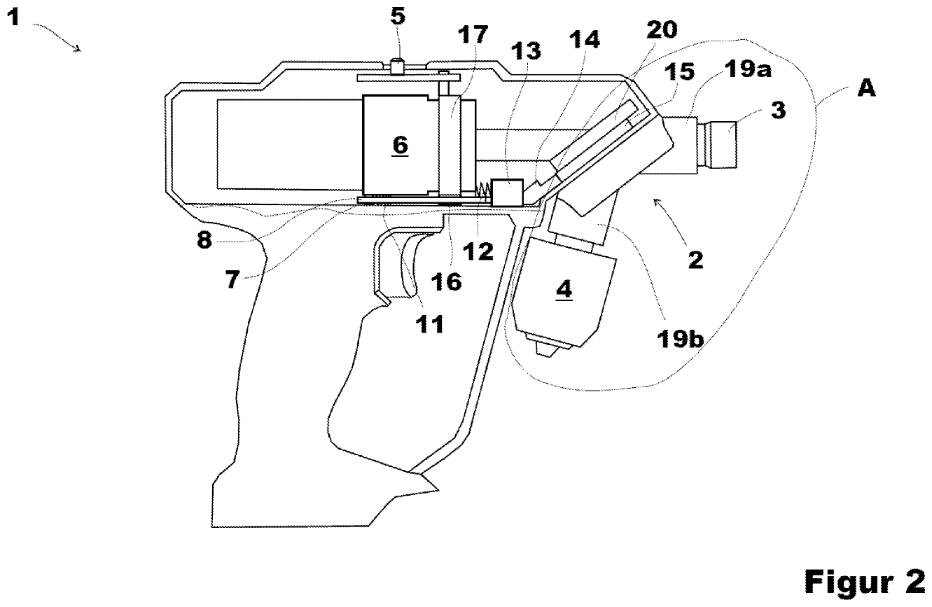

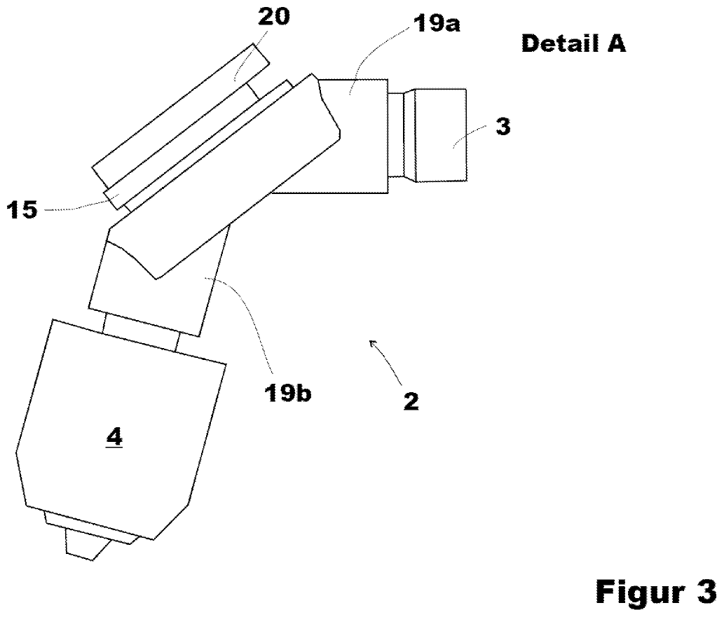

The interior of housing 18 is visible thanks to the specific manner of depiction of FIG. 2 which shows, inter alia, gearbox 6 that is shifted via a lower-side lever 7. A slider 8 arranged below gearbox 6 is provided for actuation of lever 7, which projects through an opening 10 of slider 8. Opening 10 has a surrounding edge 21, lever 7 being actuatable by a sub-region of the edge upon displacement of slider 8.

Shifting from the first gear ratio into the second gear ratio is effected directly by edge 21 upon displacement of the slider toward turret head 2, whereas shifting from the second into the first gear ratio is effected via a spring 11 that is arranged in opening 10 between the turret-head-side edge of opening 10 and lever 7.

Sliding element 5 is connected to slider 8 via intermediate elements in such a way that when sliding element 5 is slid while second coupling head 19b is active, shifting into the first gear ratio is effected. One intermediate element is embodied as a ring 17 that is arranged translationally displaceably around a sub-region of gearbox 6 and is displaceable by displacement of sliding element 5. Ring 17 in turn comprises a cam 16, and slider 8 is equipped with an elongated hole 9; cam 16 engages into elongated hole 9 in such a way that when sliding element 5 is slid while second coupling head 19b is active, shifting into the first gear ratio is effected.

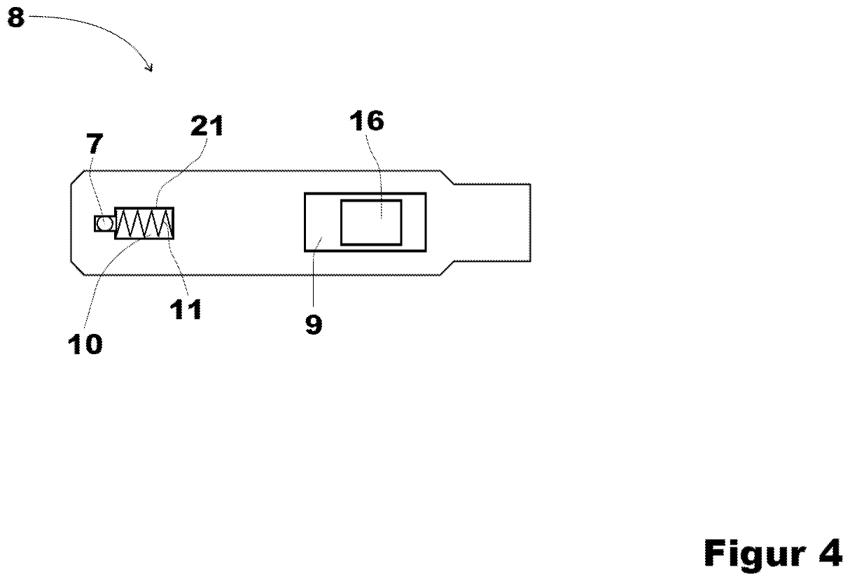

As is evident from FIG. 4, elongated hole 9 is embodied and arranged in such a way that even when slider 8 has been displaced by eccentric 15, cam 16 is located unrestrictedly within elongated hole 9.

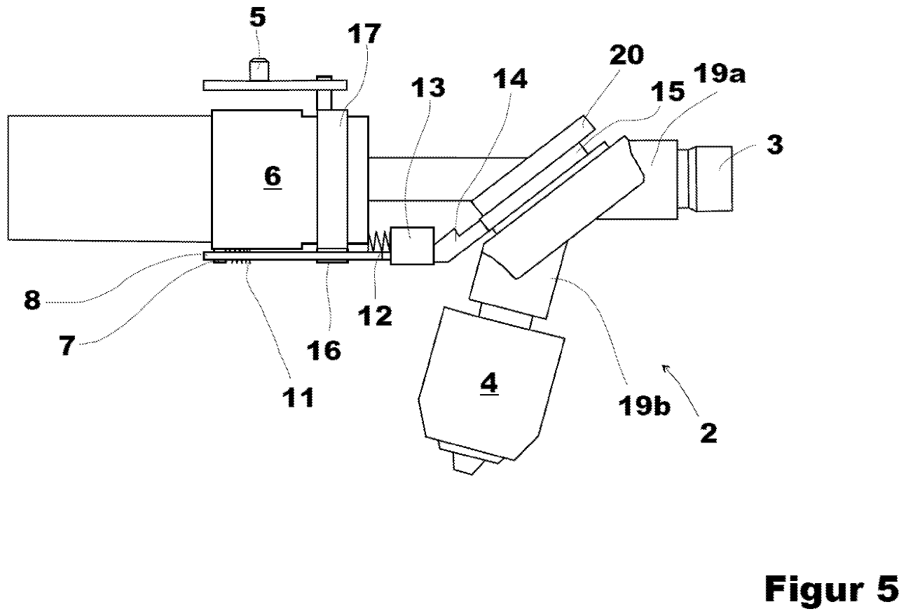

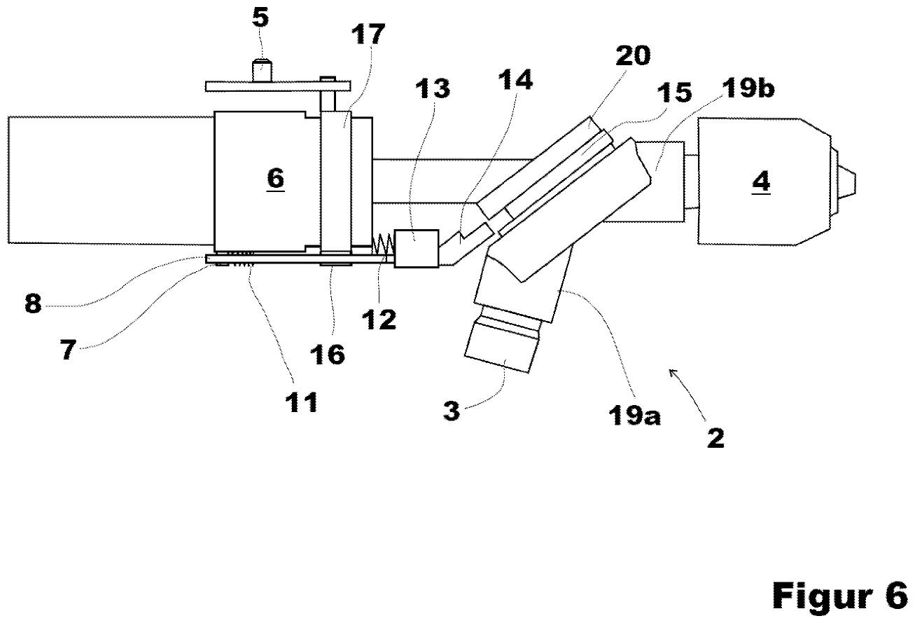

If sliding element 5 is now, as shown in FIGS. 5 and 6, displaced into its position, facing away from turret head 2, in the first gear ratio, it then also pulls ring 17 into its position facing away from turret head 2. Cam 16 entrains slider 8 and moves it into its position facing away from turret head 2, with the result that lever 7 then becomes displaced by spring 11, and gearbox 6 is thereby shifted into the first gear ratio.

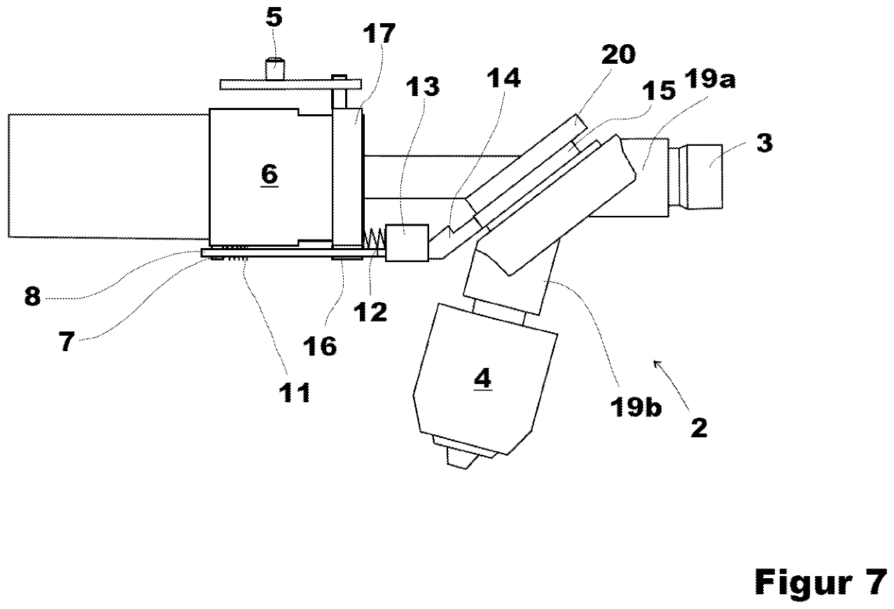

If, conversely, as shown in FIGS. 7, 8, and 9, sliding element 5 is in the position facing toward turret head 2 and corresponding to the second gear ratio of gearbox 6, ring 17 then has no further influence via its cam 16 on the position of slider 8, since because of elongated hole 9, slider 8 can move unrestrictedly around cam 16 into its two positions.

As is also evident, the position of slider 8 is now determined exclusively by the setting of turret head 2. Associated with turret head 2 for this purpose is an eccentric 15 that is fixedly coupled to the rotational motion of turret head 2 and, upon rotation of turret head 2 upon a change from second coupling head 19b to first coupling head 19a, acts via a linkage piece 14 on a pushbutton 13 and displaces the latter away from turret head 2. As shown in FIG. 7, pushbutton 13 in turn shifts slider 8 into its position facing away from turret head 2, with the result that gearbox 6 becomes shifted, via spring 11 and lever 7, into the first gear ratio. If gearbox 6 happens to be in a position such that a displacement of lever 7 into the first gear ratio is not possible, spring 11 becomes compressed. As soon as gearbox 6 then rotates slightly as handheld tool 1 is used, lever 7 can shift into the first gear ratio, actuated by the spring force of the compressed spring 11.

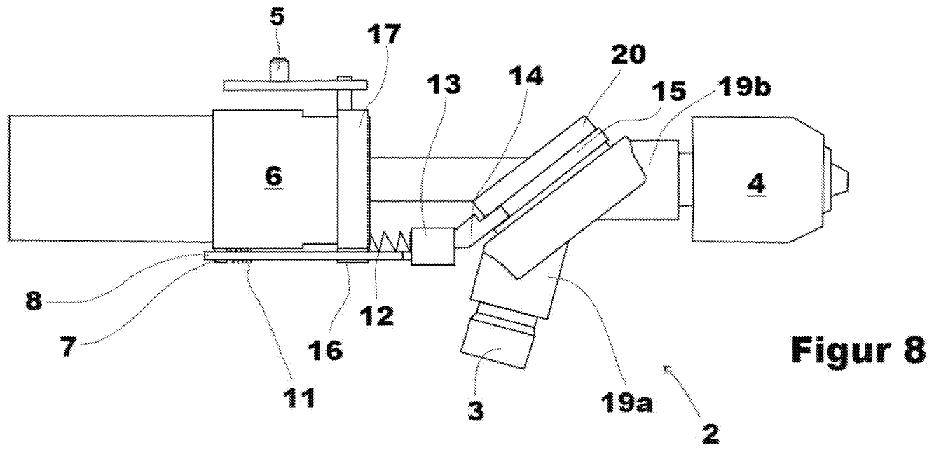

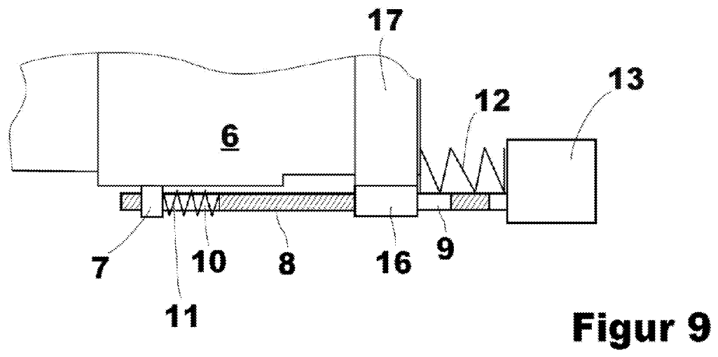

If, conversely, turret head 2 is in the position for drilling (see FIGS. 8 and 9), second coupling head 19b is then in its active position and eccentric 15 releases linkage piece 14. A spring element 12, which abuts at one end against gearbox 6 and at the other end against pushbutton 13, pushes pushbutton 13 toward turret head 2; pushbutton 13 entrains slider 8, which in turn moves lever 7 toward turret head 2 and thus shifts gearbox 6 into the second gear ratio.

Spring 11 is not compressed, or at least is not greatly compressed, in this context, and lever 7 abuts against that position of opening 8 of slider 10 which faces away from turret head 2.

1. A motor-driven handheld tool (1) for drilling and/or screwdriving, having a housing (18) in which on the one hand a motor drive system having a rotatably mounted drive shaft connected thereto is provided, and on which on the other hand a turret head (2), which is equipped at least with a drivable first coupling head (19a) having a receptacle for a screwdriving tool (3) and with a second coupling head (19b) having a receptacle for a drilling tool (4), is arranged by means of a rotary bearing; the coupling heads (19a, 19b) being capable of being pivoted alternatively both into a driven active position and into a non-driven parked position; the handheld tool (1) encompassing a shiftable gearbox (6) having at least a first gear ratio having a lower rotation speed and higher torque, and a second gear ratio having a higher rotation speed and lower torque,
wherein a control system of the gearbox (6) is provided in such a way that the first gear ratio is activated when the first coupling head (19a) is active, and the first or second gear ratio is usable when the second coupling head (19b) is active.

2. The handheld tool (1) according to claim 1, wherein the control system is embodied in such a way that upon the change from the second coupling head (19b) to the first coupling head (19a), a switchover into the first gear ratio is automatically effected.

3. The handheld tool (1) according to claim 1, wherein the control system is embodied in such a way that upon the change from the first coupling head (19a) to the second coupling head (19b), a switchover into the gear ratio that was set before utilization of the first gear ratio is automatically effected.

4. The handheld tool (1) according to claim 1, wherein the handheld tool (1) has a pistol-like shape with an elongated body and a handle provided at an angle thereto, the rotation axis of the rotary bearing of the turret head (2) being oriented at an angle of approximately 30 to 60 degrees with respect to the longitudinal extent of the elongated body.

5. The handheld tool (1) according to claim 1, wherein the coupling heads (19a, 19b) are provided on the turret head (2) in such a way that the active coupling head (19a, 19b) aligns with the elongated body, and the non-active coupling head (19a, 19b) is located below, facing to the rear at an obtuse angle with respect to the active coupling head (19a, 19b).

6. The handheld tool (1) according to claim 1, wherein when the second coupling head (19b) is active, the active gear ratio is selectable manually by means of an actuation element, preferably in the form of a sliding element (5), or a control system is provided which switches over to the gear ratio on the basis of the load.

7. The handheld tool (1) according to claim 1, wherein the control system of the gearbox (6) is embodied entirely mechanically, and the gearbox (6) comprises for that purpose a lever (7) displaceable between positions corresponding to the first gear ratio or to the second gear ratio.

8. The handheld tool (1) according to claim 1, wherein the displacement direction of the lever (7) is oriented in alignment with the longitudinal extent of the elongated body of the handheld tool (1).

9. The handheld tool (1) according to claim 8, wherein when the first gear ratio is set, the lever (7) is in a setting that faces away from the turret head (2); and when the second gear ratio is set, the lever (7) is in a setting that faces toward the turret head (2).

10. The handheld tool (1) according to claim 5, wherein the turret head (2) is equipped with an eccentric (15) by way of which the lever (7) is actuatable, directly or via at least one connecting element, for shifting into the first gear ratio against the return force of a spring element (12).

11. The handheld tool (1) according to claim 10, wherein a connecting element is embodied as a slider (8) that comprises an opening (10) having a surrounding edge (21), the lever (7) being surrounded by the opening (10) and being actuatable by a sub-region of the edge (21), directly or by way of an interposed spring (11), upon displacement of the slider (8).

12. The handheld tool (1) according to claim 10, wherein a connecting element is embodied as a pushbutton (13) attached to the slider (8).

13. The handheld tool (1) according to claim 10, wherein a connecting element is embodied as a linkage piece (14) which is provided between the pushbutton (13) and eccentric (15), and which on the one hand is displaceable by the eccentric (15) along a guide oriented orthogonally to the rotation axis of the rotary bearing and facing toward the gearbox (6), and on the other hand has at its one end a contact surface impinged upon by the eccentric (15) and is equipped at its other end with a planar contact region for impingement of the pushbutton (13).

14. The handheld tool (1) according to claim 11, wherein the sliding element (5) is connected to the slider (8), directly or via at least one intermediate element, in such a way that shifting into the first gear ratio is effected by sliding of the sliding element (5) when the second coupling head (19b) is active.

15. The handheld tool (1) according to claim 14, wherein an intermediate element is embodied as a ring (17) that is arranged translationally displaceably around a sub-region of the gearbox (6) and is displaceable by displacement of the sliding element (5).

16. The handheld tool (1) according to claim 15, wherein the ring (17) comprises a cam (16), and the slider (8) is equipped with an elongated hole (9), the cam (16) engaging into the elongated hole (9) in such a way that shifting into the first gear ratio is effected by sliding of the sliding element (5) when the second coupling head (19b) is active.

17. The handheld tool (1) according to claim 16, wherein the elongated hole (9) is embodied and arranged in such a way that even when the slider (8) has been displaced by the eccentric (15), the cam (16) is located unrestrictedly within the elongated hole (9).

18. The handheld tool (1) according to claim 1, wherein shifting into the second gear ratio is effected by way of a spring (11), the spring (11) having a lower spring force than the spring element (12).
